(19) United States
(12) Patent Application Publication
(10) Pub. No.: US 2026/0119463 A1
(43) Pub. Date: Apr. 30, 2026

(54) METHOD AND SYSTEM FOR TRANSFORMING DATA TO STREAMLINE DATA CONSUMPTION

(71) Applicant: JPMorgan Chase Bank, N.A., New York, NY (US)

(72) Inventor: Chandra GUPTA, Jersey City, NJ (US)

(73) Assignee: JPMorgan Chase Bank, N.A., New York, NY (US)

(21) Appl. No.: 19/355,834

(22) Filed: Oct. 10, 2025

Related U.S. Application Data
(60) Provisional application No. 63/711,572, filed on Oct. 24, 2024.

(51) Int. Cl. G06F 16/21; G06F 16/2455; G06F 18/21; G06N 5/025; G06Q 40/02

(52) U.S. Cl. CPC G06F 16/211; G06F 16/24568; G06F 18/217; G06N 5/025; G06Q 40/0222

(57) ABSTRACT

A method and a system for streamlining data processing by transforming data are provided. The method includes: receiving first data that relates to a customer interaction event from at least one system of record (SOR); validating, via a domain specific language, the first data based on a first series of rules to confirm that each datum from the first data is capable of being transformed; generating second data by removing each datum from the first data that is incapable of being transformed; transforming the second data from a first format to a second format based on a second series of rules; and transmitting the transformed data to each respective SOR.

### CROSS-REFERENCE TO RELATED APPLICATIONS

This application claims priority benefit from U.S. Provisional Application No. 63/711,572, filed on Oct. 24, 2024, in the U.S. Patent and Trademark Office, which is hereby incorporated by reference in its entirety.

### FIELD OF THE DISCLOSURE

This disclosure generally relates to methods and systems for streamlining data processing by transforming data, and more particularly to methods and systems for transforming data from a variety of sources and formats into a custom singular format that facilitates data processing across a plurality of platforms.

### Background Information

As consumer and credit banking systems continue to mature and implement new features, the volume of consumer and credit banking events continues to grow significantly. The autonomy of data publishers to define their event payloads will continue to cause friction for some data consumers as they need to modify the data to fit their consumption needs.

Some data consumers need to execute transformations, enrichments, or filtering actions on event data to make the data fit for their consumption needs. In some instances, the rules for transformation, enrichment, or filtering may be continually evolving and changing. Consumers need a method to abstract changes in these business rules from the application code to facilitate more frequent changes without the need to significantly change and test application code.

Within retail banking systems, there are multiple systems of records (SORs) (i.e., publishers) that send data to the banking systems in various shapes, forms, variety, and velocity. The challenge then becomes the transformation of the SOR data in order to enrich and filter data, primarily in the context of eventing (i.e., the real time streaming of data (e.g., within the context of a data streaming platform)).

Currently, no such capacity or tool kit is available to provide all the transformations and enrichment filtering for retail and consumer banking services. The SORs publish the data, which causes friction for the consumer that needs to modify the data to fit their own consumption needs. The consumer has to write their own code base, and has to do all the due diligence, and go through the whole life cycle of the software development.

Accordingly, there is a need for transforming data from a variety of sources and formats into a custom singular format that facilitates data processing across a plurality of platforms in order to provide all the transformations and enrichment filtering for retail and consumer banking services in an integrated platform. Particularly, a service is needed for validating and transforming data streams in order to provide data that is more easily analyzed, processed, and modifiable to consumers'needs. Additionally, a system is needed for modeling and managing complex data relationships within event data streams.

### SUMMARY

The present disclosure, through one or more of its various aspects, embodiments, and/or specific features or sub-components, provides, inter alia, various systems, servers, devices, methods, media, programs, and platforms for identifying potential reliability issues regarding user interactions within a platform and generating potential actions to address the identified issues.

According to an aspect of the present disclosure, a method for streamlining data processing by transforming data is provided. The method may be implemented by at least one processor. The method may include: receiving, by the at least one processor, first data that relates to a customer interaction event from at least one system of record (SOR); validating, by the at least one processor via a domain specific language (DSL), the first data based on a first series of rules to confirm that each datum from the first data is capable of being transformed; generating, by the at least one processor, second data by removing each datum from the first data that is incapable of being transformed; transforming, by the at least one processor, the second data from a first format to a second format based on a second series of rules, wherein the second format is a standardized DSL format that is recognizable by each SOR; and transmitting, by the at least one processor, the transformed second data to each respective SOR.

The method may further include augmenting, by the at least one processor via a database and at least one application programming interface (API), the transformed second data with historical reference data.

The validating may include applying a set of conditional rules to evaluate a dynamic value of the first data based on a predetermined logical type and a predetermined functional value.

The method may further include storing, by the at least one processor via a cache manager, a cache of at least one from among frequently used rules that relate to previous transformations of prior data and previously computed results that relate to the previous transformations of prior data. Information associated with the cache may be used to reduce a number of computations required for the transforming of the second data.

The method may further include: defining, by the at least one processor, a customer interaction event response workflow based on the transformed second data and a set of workflow rules associated with the DSL; and executing, by the at least one processor, the defined customer interaction event response workflow based on the set of workflow rules.

The customer interaction event may comprise at least one from among a customer checking a detail of an account, a request for a new banking card, a request to add a new payment to the account, and a transaction associated with the account.

The method may further include generating, by the at least one processor via a machine learning model, a summary of the transformed second data in the second format that describes the customer interaction event.

The method may further include analyzing, by the at least one processor via the machine learning model, the generated summary to interpret the transformed second data, determine a pattern, and generate a recommended responsive action.

The at least one SOR may comprise a stream-processing platform.

According to another aspect of the present disclosure, a computing apparatus for streamlining data processing by transforming data is provided. The computing apparatus may include a processor; a memory; and a communication interface coupled to each of the processor, and the memory. The processor may be configured to: receive first data that relates to a customer interaction event from at least one system of record (SOR); validate, via a domain specific language (DSL), the first data based on a first series of rules to confirm that each datum from the first data is capable of being transformed; generate second data by removing each datum from the first data that is incapable of being transformed; transform the second data from a first format to a second format based on a second series of rules, wherein the second format is a standardized DSL format that is recognizable by each SOR; and transmit the transformed second data to each respective SOR.

The processor may be further configured to augment, via a database and at least one application programming interface (API), the transformed second data with historical reference data.

The processor may be further configured to apply a set of conditional rules to evaluate a dynamic value of the first data based on a predetermined logical type and a predetermined functional value.

The processor may be further configured to: store, via a cache manager, a cache of at least one from among frequently used rules that relate to previous transformations of prior data and previously computed results that relate to the previous transformations of prior data. The information associated with the cache may be used to reduce a number of computations required for the transforming of the second data.

The processor may be further configured to: define a customer interaction event response workflow based on the transformed second data and a set of workflow rules associated with the DSL; and execute the defined customer interaction event response workflow based on the set of workflow rules.

The customer interaction event may include at least one from among a customer checking a detail of an account, a request for a new banking card, a request to add a new payment to the account, and a transaction associated with the account.

The processor may be further configured to generate, via a machine learning model, a summary of the transformed second data that describes the customer interaction event.

The processor may be further configured to: analyze, via the machine learning model, the generated summary to interpret the transformed second data, determine a pattern, and generate a recommended responsive action.

The at least one SOR may include a stream-processing platform.

According to yet another aspect of the present disclosure, a non-transitory computer readable storage medium storing instructions for streamlining data processing by transforming data is provided. The storage medium includes executable code which, when executed by a processor, may cause the processor to: receive first data that relates to a customer interaction event from at least one system of record (SOR); validate, via a domain specific language (DSL), the first data based on a first series of rules to confirm that each datum from the first data is capable of being transformed; generate second data by removing each datum from the first data that is incapable of being transformed; transform the second data from a first format to a second format based on a second series of rules, wherein the second format is a standardized DSL format that is recognizable by each SOR; and transmit the transformed second data to each respective SOR.

The executable code may further cause the processor to augment, via a database and at least one application programming interface (API), the transformed second data with historical reference data.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for transforming data from a variety of sources and formats into a custom singular format that facilitates data processing across a plurality of platforms, according to an embodiment.

FIG. 2 illustrates a diagram of a network environment for transforming data from a variety of sources and formats into a custom singular format that facilitates data processing across a plurality of platforms, according to an embodiment.

FIG. 3 illustrates a system diagram of a system for transforming data from a variety of sources and formats into a custom singular format that facilitates data processing across a plurality of platforms, according to an embodiment.

FIG. 4 illustrates a process diagram of a process for transforming data from a variety of sources and formats into a custom singular format that facilitates data processing across a plurality of platforms, according to an embodiment.

FIG. 5 illustrates a flow diagram of a process for transforming data from a variety of sources and formats into a custom singular format that facilitates data processing across a plurality of platforms, according to an embodiment.

FIG. 6 illustrates an architectural flow diagram of a process for transforming data from a variety of sources and formats into a custom singular format that facilitates data processing across a plurality of platforms, according to an embodiment.

FIG. 7 illustrates a technical flow diagram of a process for transforming data from a variety of sources and formats into a custom singular format that facilitates data processing across a plurality of platforms, according to an embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art will appreciate that these blocks, units, and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or similar, they may be programmed using software (e.g., microcode) to perform various functions discussed herein and may optionally be driven by firmware and/or software. Alternatively, each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of the example embodiments may be physically separated into two or more interacting and discrete blocks, units, and/or modules without departing from the scope of the inventive concepts. Further, the blocks, units, and/or modules of the example embodiments may be physically combined into more complex blocks, units, and/or modules without departing from the scope of the present disclosure.

A system or method disclosed herein transforms, enriches, and filters event data for a data consumers consumption needs. Particularly, the system receives data that relates to an interaction between a customer and a digital platform, such as a business and/or banking website or application. The data may be a stream of data that is continuously published as users interact with the platform. The data may also be in a variety of formats and come from a variety of different systems, modules, or SORs that each may have their own format. The system then collects and assembles all the data that is coming in from the SORs. Next, the system utilizes a DSL and applies a series of rules based on the DSL to validate the assembled the data. Once the data is validated the system applies another series of rules based on the DSL to transform the data into a standardized format that can easily be recognized and processed by data consumers. The system then transmits the transformed data back to the SORs so that it is easily identifiable and digestible within the SORs.

By leveraging a DSL to manage validation and transformation of data streams, the system provides data that is more easily analyzed, processed, and modifiable to consumers'needs, thus, streamlining data processing. The system may also extend entity definitions based on pivotal elements and adhere to various rules to provide a flexible and scalable approach to modeling and managing complex data relationships within event data streams. Moreover, the system may incorporate a domain-specific expression language, allowing organizations to define rules and extraction logic specific to their business domain. This empowers data experts and domain specialists to express complex business rules in a concise and intuitive manner. Furthermore, the system may enable the dynamic application of rules by utilizing external configuration sources such as databases or configuration services in order to provide real-time adaptability and flexibility to accommodate evolving product requirements. The system may also simplify the development of rules and policies by utilizing a DSL. This language allows users to define rules for filtering, aggregating, enriching, or modifying events based on specific conditions or business logic which enables the system to implement and manage complex data processing rules within their data streams. Additionally, the system may seamlessly integrate with existing data processing pipelines and can scale to handle large volumes of data. It may support integration with popular stream processing frameworks, ensuring compatibility and adaptability to diverse environments. Moreover, by facilitating updates to rules and policies, organizations can evolve their data governance and validation strategies as data requirements evolve, ensuring ongoing alignment with business needs. Each of these features facilitates the streamlining of data processing for transforming data from a variety of sources and formats into a custom singular format that facilitates data processing across a plurality of platforms.

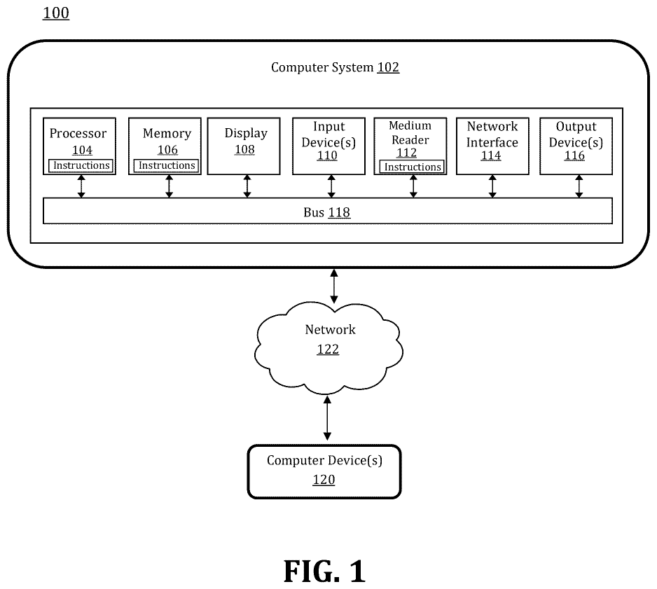

FIG. 1 is a system 100 for transforming data from a variety of sources and formats into a custom singular format that facilitates data processing across a plurality of platforms, in accordance with an embodiment. The system 100 is generally shown and may include a computer system 102, which is generally indicated.

The computer system 102 may include a set of instructions that may be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks, or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions may be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a GPS device, a visual positioning system (VPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, may be used to perform one or more of the methods and processes as described herein. In an embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, and serial advanced technology attachment.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, infrared, near field communication, ultraband, or any combination thereof. Those skilled in the art appreciate that additional networks 122 which are known and understood may additionally or alternatively be used and that networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 may be a personal computer. However, those skilled in the art appreciate that, in alternative embodiments of the present application, the computer device 120 may also be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In some embodiments, the data transformation module implemented by the system 100 may allow for transforming data from a variety of sources and formats into a custom singular format that facilitates data processing across a plurality of platforms. The configuration or data files, in some embodiments, may be written using JavaScript Object Notation (JSON), but the disclosure is not limited thereto. For example, the configuration or data files may easily be extended to other readable file formats such as Extensible Markup Language (XML), Yet Another Markup Language (YAML), or any other configuration-based languages.

In accordance with various embodiments of the present disclosure, the methods described herein may be implemented using a hardware computer system that executes software programs. Further, in a non-limited embodiment, implementations can include distributed processing, component/object distributed processing, and an operation mode having parallel processing capabilities. Virtual computer system processing may be constructed to implement one or more of the methods or functionalities as described herein, and a processor described herein may be used to support a virtual processing environment.

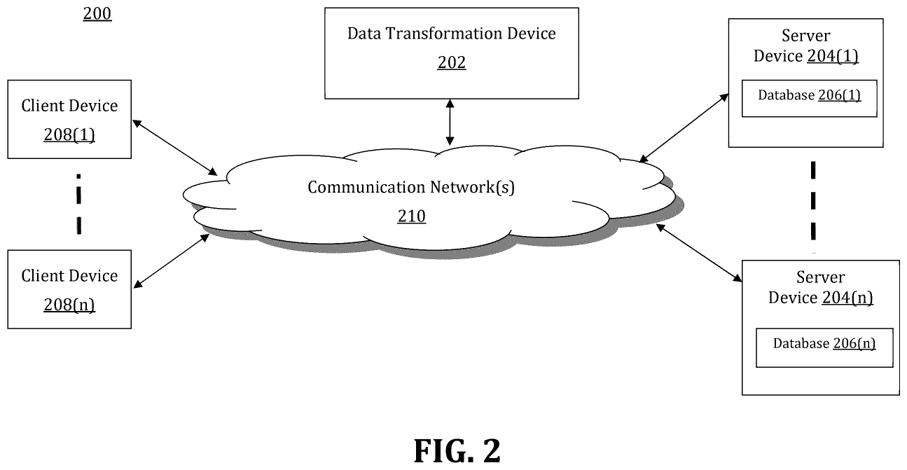

Referring to FIG. 2, a schematic of a network environment 200 for transforming data from a variety of sources and formats into a custom singular format that facilitates data processing across a plurality of platforms is illustrated.

In some embodiments, the above-described problems associated with conventional tools may be overcome by implementing a data transformation device 202 as illustrated in FIG. 2 that may be configured for transforming data from a variety of sources and formats into a custom singular format that facilitates data processing across a plurality of platforms, but the disclosure is not limited thereto.

The data transformation device 202 may include one or more computer systems 102, as described with respect to FIG. 1, which in aggregate provide the necessary functions.

The data transformation device 202 may store one or more applications that can include executable instructions that, when executed by the data transformation device 202, cause the data transformation device 202 to perform actions, such as to transmit, receive, or otherwise process network messages, for example, and to perform other actions described and illustrated below with reference to the figures. The application(s) may be implemented as modules or components of other applications. Further, the application(s) may be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the data transformation device 202 itself, may be located in virtual server(s) running in a cloud-based computing environment rather than being tied to one or more specific physical network computing devices. Also, the application(s) may be running in one or more virtual machines (VMs) executing on the data transformation device 202. Additionally, in one or more embodiments of this technology, virtual machine(s) running on the data transformation device 202 may be managed or supervised by a hypervisor.

In the network environment 200 of FIG. 2, the data transformation device 202 may be coupled to a plurality of server devices 204(1)-204(n) that hosts a plurality of databases 206(1)-206(n), and also to a plurality of client devices 208(1)-208(n) via communication network(s) 210. A communication interface of the data transformation device 202, such as the network interface 114 of the computer system 102 of FIG. 1, operatively couples and communicates between the data transformation device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the data transformation device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein.

By way of example only, the communication network(s) 210 may include local area network(s) (LAN(s)) or wide area network(s) (WAN(s)), and can use Transmission Control Protocol/Internet Protocol (TCP/IP) over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The data transformation device 202 may be a standalone device or integrated with one or more other devices or apparatuses, such as one or more of the server devices 204(1)-204(n), for example. In one example, the data transformation device 202 may be hosted by one of the server devices 204(1)-204(n), and other arrangements are also possible. Moreover, one or more of the devices of the data transformation device 202 may be in the same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the authentication device 202 via the communication network(s) 210 according to the Hypertext Transfer Protocol (HTTP)-based and/or JSON protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store data sets, data quality rules, and newly generated data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. Client device in this context refers to any computing device that interfaces to communications network(s) 210 to obtain resources from one or more server devices 204(1)-204(n) or other client devices 208(1)-208(n).

In some embodiments, the client devices 208(1)-208(n) in this example may include any type of computing device that can facilitate the implementation of the data transformation device 202 that may transform data from a variety of sources and formats into a custom singular format that facilitates data processing across a plurality of platforms, but the disclosure is not limited thereto.

The client devices 208(1)-208(n) may run interface applications, such as standard web browsers or standalone client applications, which may provide an interface to communicate with the customer journey reliability device 202 via the communication network(s) 210 in order to communicate user requests. The client devices 208(1)-208(n) may further include, among other features, a display device, such as a display screen or touchscreen, and/or an input device, such as a keyboard, for example.

Although the network environment 200 with the data transformation device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as may be appreciated by those skilled in the relevant art(s).

One or more of the devices depicted in the network environment 200, such as the data transformation device 202, the server devices 204(1)-204(n), or the client devices 208(1)-208(n), for example, may be configured to operate as virtual instances on the same physical machine. For example, one or more of the data transformation devices 202, the server devices 204(1)-204(n), or the client devices 208(1)-208(n) may operate on the same physical device rather than as separate devices communicating through communication network(s) 210. Additionally, there may be more or fewer data transformation devices 202, server devices 204(1)-204(n), or client devices 208(1)-208(n) than illustrated in FIG. 2. In some embodiments, the data transformation device 202 may be configured to send code at run-time to remote server devices 204(1)-204(n), but the disclosure is not limited thereto.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

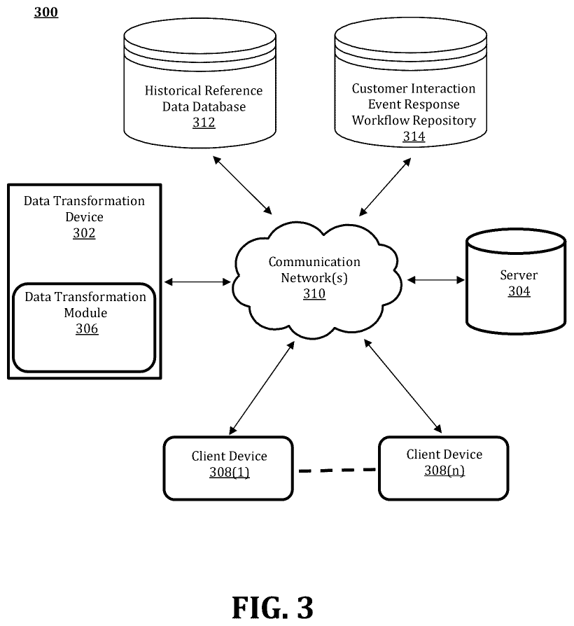

FIG. 3 illustrates a system diagram for transforming data from a variety of sources and formats into a custom singular format that facilitates data processing across a plurality of platforms, in accordance with an embodiment.

As illustrated in FIG. 3, the system 300 may include a data transformation device 302 within which a data transformation module 306 is embedded, a server 304, a historical reference data database 312, a customer interaction event response workflow repository 314, a plurality of client devices 308(1) . . . 308(n), and a communication network 310.

In some embodiments, the data transformation device 302 including the data transformation module 306 may be connected to the server 304, the historical reference data database 312, and the customer interaction event response workflow repository 314 via the communication network 310. The data transformation device 302 may also be connected to the plurality of client devices 308(1) . . . 308(n) via the communication network 310, but the disclosure is not limited thereto. The historical reference data database 312 and the customer interaction event response workflow repository 314 may include one or more repositories or databases.

In an embodiment, the data transformation device 302 is described and shown in FIG. 3 as including the data transformation module 306, although it may include other rules, policies, modules, databases, or applications, for example. In some embodiments, the historical reference data database 312 and the customer interaction event response workflow repository 314 may be configured to store ready to use modules written for each API for all environments. Although only one database and one repository are illustrated in FIG. 3, the disclosure is not limited thereto. Any number of desired databases and/or repositories may be utilized for use in the disclosed invention herein. The historical reference data database 312 and the customer interaction event response workflow repository 314 may be a mainframe database, a log database that may produce programming for searching, monitoring, and analyzing machine-generated data via a web interface, but the disclosure is not limited thereto. In addition, the historical reference data database 312 and the customer interaction event response workflow repository 314 may store a plurality of data sets and predictive models for transforming data.

In some embodiments, the data transformation module 306 may be configured to receive real-time feed of data from the plurality of client devices 308(1) . . . 308(n) and secondary sources via the communication network 310.

The data transformation module 306 may be configured to: receive data that relates to a customer interaction event from at least one SOR; assemble the data from each SOR of the at least one SOR; validate, via a DSL, the assembled data based on a first series of rules; transform the validated data from a first format to a second format based on a second series of rules; and transmit the transformed data to each respective SOR.

The plurality of client devices 308(1) . . . 308(n) are illustrated as being in communication with the data transformation device 302. In this regard, the plurality of client devices 308(1) . . . 308(n) may be “clients” (e.g., customers) of the data transformation device 302 and are described herein as such. Nevertheless, it is to be known and understood that the plurality of client devices 308(1) . . . 308(n) need not necessarily be “clients” of the data transformation device 302, or any entity described in association therewith herein. Any additional or alternative relationship may exist between either or both plurality of client devices 308(1) . . . 308(n) and the data transformation device 302, or no relationship may exist.

The first client device 308(1) may be, for example, a smart phone. Of course, the first client device 308(1) may be any additional device described herein. The second client device 308(n) may be, for example, a personal computer (PC). Of course, the second client device 308(n) may also be any additional device described herein. In some embodiments, the server 304 may be the same or equivalent to the server device 204 as illustrated in FIG. 2.

The process may be executed via the communication network 310, which may comprise plural networks as described above. For example, in an embodiment, one or more of the pluralities of client devices 308(1) . . . 308(n) may communicate with the data transformation device 302 via broadband or cellular communication. Of course, these embodiments are merely exemplary and are not limiting or exhaustive.

The client devices 308(1)-308(n) may be the same or similar to any one of the client devices 208(1)-208(n) as described with respect to FIG. 2, including any features or combination of features described with respect thereto. The data transformation device 302 may be the same or similar to the data transformation device 202 as described with respect to FIG. 2, including any features or combination of features described with respect thereto.

Upon being started, the data transformation device 302 executes a process for transforming data from a variety of sources and formats into a custom singular format that facilitates data processing across a plurality of platforms.

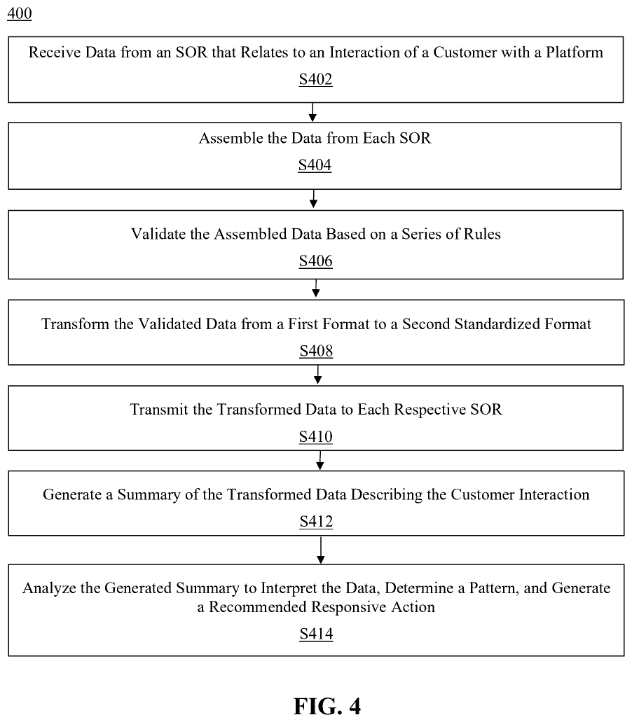

FIG. 4 illustrates a process 400 for transforming data from a variety of sources and formats into a custom singular format that facilitates data processing across a plurality of platforms, according to an embodiment.

In process 400 of FIG. 4, at step S402, the data transformation device 302 may receive data that relates to a customer interaction event from at least one SOR. In an embodiment, the data may relate to any set or collection of data or values that may be associated with an account. For example, the data may relate to consumer account details including balances, transactions, and/or customer interaction details. In some embodiments, the customer interaction event may include a customer performing an action on a business or organization website, platform, or application. For example, according to an embodiment, the customer interaction event may include a customer checking a detail of an account, a request for a new banking card, a request to add a new payment to the account, or a transaction associated with the account. In an embodiment, the SOR may be a data publisher that streams and/or publishes the data as the customer interaction events occur. In some embodiments, the SOR may be a distributed event store and stream-processing platform (e.g., Apache Kafka). In some embodiments, each SOR may be associated with a different source, channel, API, and/or division of the platform, business, or organization. For example, one SOR may be associated with a division of the organization that handles customer events corresponding to the checking of account details and another SOR may be associated with handling requests for adding new payments to an account. In an embodiment, a customer may be interacting with the business or organization through multiple channels, and each channel may have different types of information and different ways of textualizing that information.

At step S404, the data transformation device 302 may assemble the data from each SOR. In some embodiments, the data transformation device 302 may collect and assemble all the information coming from all the different sources, channels, and/or SORs where the customer is interacting with the organization.

At step S406, the data transformation device 302 may validate the assembled data based on a series of validation rules associated with a DSL. The validation rules may be a set of conditional rules that evaluate the logical type and functional value of the data. For example, the rules may dictate that an incoming event having a specific field value may be filtered out and that an event having a different field value may cause the system to generate a message or alert that goes to a system manager. For example, the data transformation device 302 may analyze the assembled data with regard to each of the validation rules to ensure that the data is valid and capable of being transformed. The DSL may be a customized computing language. In an embodiment, the DSL may be an integration of various computing languages (e.g., Spring Expression Language (SpEL) and JavaScript Object Notation Path (JSONPath)). The series of rules may be customized, codified, and configured in the DSL.

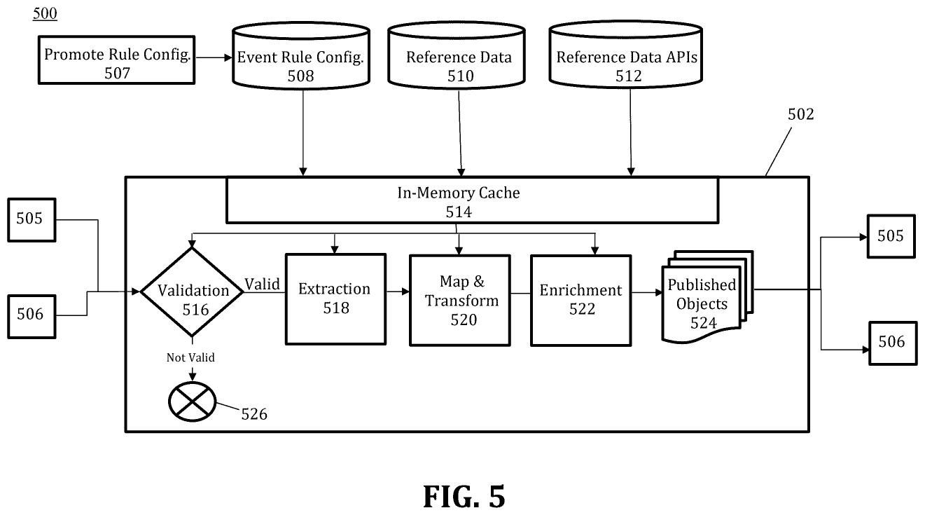

At step S408, the data transformation device 302 may transform the validated data from the original format to a standardized format based on a series of transformation rules associated with the DSL (as further illustrated in FIGS. 5, 6, and 7). For example, according to an embodiment, the data transformation device 302 may transform all the data relating to the customer interaction event that is received from a plurality of different sources, each with a different formatting language or standard, into a single standardized DSL format that is recognized by data consumers. In an embodiment, the data transformation device 302 may convert the data from one format to another format using certain custom rules that have specific semantics associated with the organization and can be plugged into the system. In some embodiments, the data transformation device 302 may perform complex mathematical formulas or conditional formulas in order to transform the data, based on conditions involved. In an embodiment, the data transformation device 302 may apply a set of conditional rules to evaluate a dynamic value of the assembled data based on a predetermined logical type and a predetermined functional value. For example, according to an embodiment, the data events may be validated against a set of conditional rules, which evaluate the dynamic values of the field on both the logical type and functional value of the field. The rules may then be used to either filter out the incoming data event or respond with a custom exception code.

In an embodiment, the data transformation device 302 may augment the transformed data with historical reference data extracted from a database and an API. For example, according to an embodiment, certain fields and/or logic of the transformed data may be enriched or augmented with reference data that is queried from connected databases and configured APIs. In some embodiments, the data transformation device 302 may include a cache manager that stores a cache of frequently used rules that relate to previous transformations of data and previously computed results that relate to the previous transformations of data. The data transformation device 302 may use the information from the cache manager to reduce the number of computations required for transforming the data, by ensuring that only necessary computations are performed.

In an embodiment, the data transformation device 302 may define a customer interaction event response workflow (i.e., a series of tasks and processes to be performed by the system) based on the transformed data and a set of workflow rules associated with the DSL. The data transformation device 302 may then execute the defined customer interaction event response workflow based on the set of workflow rules. In some embodiments, the workflow may be customized for stream-processing platform events, allowing for real-time data processing with minimal custom code. In an embodiment, the cache manager may further accelerate workflow execution by reducing the overhead associated with rule evaluation. Once the workflow is executed, the transformed data may be transmitted back to the SORs.

At step S410, the data transformation device 302 may transmit the transformed data back to the respective SORs. For example, the transformed data in the standardized DSL format may be transmitted back to each of the organizational channels so that the data may be appropriately analyzed or processed.

At step S412, the data transformation device 302 may generate a summary of the transformed data that describes the customer interaction event. In an embodiment, the data transformation device 302 may use a machine learning (ML) model to interpret the transformed data and generate a summarized explanation of the customer interaction. For example, according to an embodiment, the data transformation device 302 may summarize that the customer is replacing a lost banking card, based on the transformed data of the customer interaction event.

Then, at step S414, the data transformation device 302 may analyze the generated summary to interpret the data, determine a pattern, and generate a recommended responsive action. For example, according to an embodiment, the data transformation device 302 may use the ML model to determine the customer intent when the customer is calling after having placed a request for card replacement through a mobile channel. The data transformation device 302 may then use the determined customer intent to generate a customized response (e.g., the system generates the response “are you calling regarding your card replacement”).

FIG. 5 illustrates a flow diagram 500 of a process for transforming data from a variety of sources and formats into a custom singular format that facilitates data processing across a plurality of platforms, according to an embodiment. FIG. 5 illustrates a detailed flow diagram of steps S406 through S410 of FIG. 4, according to an embodiment. As illustrated by FIG. 5, a stream-processing platform (e.g., Apache Kafka) 505 and an API 506 transmits data to the data transformation device 502, and specifically to the validation module 516. The validation module 516 determines whether or not the data received is valid. If the data is not valid, the data does not proceed, and the data is terminated at the data termination module 526. If the data is valid, the data proceeds to the extraction module 518, the map and transform module 520, the enrichment module 522, and is then published at the published objects module 524. The published objects are then transmitted from the published objects module 524 back to the stream-processing platform 505 and the API 506 to display the transformed data. Additionally, the promote rule configuration module 507 transmits data processing rules to the event rule configuration module 508, which feeds current rules, along with historical reference rules and data from the reference data module 510 and the reference data API module 512, to the in-memory cache 514. The in-memory cache 514 then transmits all the stored rules for analysis, processing, extraction, transformation, and enrichment to the validation module 516, the extraction module 518, the map and transform module 520, and the enrichment module 522. The validation module 516 may apply validation data based on logical type values and functional values. The extraction module 518 may extract the data for further processing, transformation, and enrichment. The map and transform module 520 may apply mappings and/or code/decode for standardization of the data. The event rule configuration module 508 may filter data event payloads before submitting to storage to reduce data storage size requirements. The enrichment module 522 may apply rules to ensure conformance with a canonical data model. Moreover, the system enables dynamic loading of reference data by the API and database to facilitate the transformation of data.

By this process, the flow diagram 500 transforms data from a variety of sources and formats into a custom singular format that facilitates data processing across a plurality of platforms.

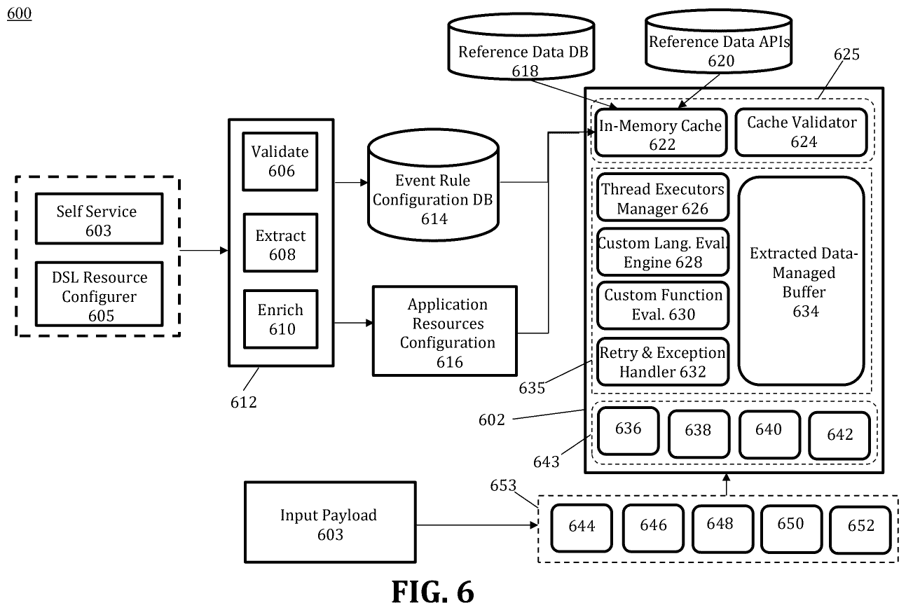

FIG. 6 illustrates an architectural flow diagram 600 of a process for transforming data from a variety of sources and formats into a custom singular format that facilitates data processing across a plurality of platforms, according to an embodiment. FIG. 6 illustrates a detailed architectural flow diagram of the process illustrated by the flow diagram 500 of FIG. 5, according to an embodiment. As illustrated by FIG. 6, both a self-service module 603 and a DSL resource configurer 605 may be used to feed data and information to the DSL configuration module 612. The DSL configuration module may include a validate module 606, an extract module 608, and an enrich module 610. The validate module 606 may apply a series of DSL configured codes to validate the received data. The extract module 608 may also apply a series of DSL configured codes to extract the received data. Additionally, the enrich module 606 may apply a series of DSL configured codes to enrich the received data. The data processed by the DSL configuration module 612 may then be transmitted to both the event rule configuration database 614 and the application resources configuration module 616. Once the data is stored and processed by the event rule configuration database 614 and the application resources configuration module 616 it is then transmitted to the in-memory cache 622 of the data transformation artifact 602. The in-memory cache 622 also receives reference data from the reference data database 618 and the reference data APIs 620. The cache from the in-memory cache 622 may be validated by the cache validator and manager 624. The in-memory cache 622 and the cache validator and manager 624 make up the managed cache component 625. The data from the managed cache component 625 may also be processed by the core component 635 which may contain a thread executors manager 626, a custom computer language evaluation engine 628, a custom function evaluator engine 630, a retry and exception handler 632, and an extracted data-managed buffer 634 to further process the data.

The data from the core component 635 and the managed cache component 625 may also be processed by the input and output handling component 643. The input and output handling component 643 may contain a data transformation template 636, a data transformation web client 638, a data transformation feign client 640, and a database transformation query manager 642 for receiving and transmitting data and information outside the data transformation artifact 602. Additionally, an input payload module 603 may transmit event data to the multi-stream component 653. The multi-stream component 653 may contain a message broker 644, a stream-processing platform 646, an API 648, a database 650, and a web socket 652, that may also process and transmit data and information to the data transformation artifact 602.

By this process, the architectural flow diagram 600 transforms data from a variety of sources and formats into a custom singular format that facilitates data processing across a plurality of platforms. Additionally, in an embodiment, the process may have a self-service feature that allows users to independently access, discover, and explore events and rules within the framework of the system. For example, these events and rules may be accessible via a user interface associated with the system.

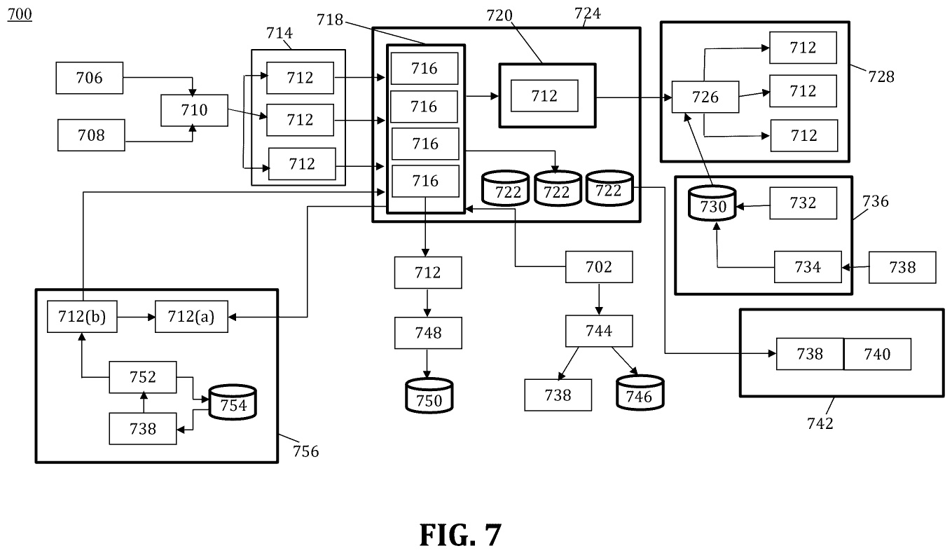

FIG. 7 illustrates a technical flow diagram 700 of a process for transforming data from a variety of sources and formats into a custom singular format that facilitates data processing across a plurality of platforms, according to an embodiment. FIG. 7 illustrates a detailed technical flow diagram of the stream processing illustrated by architectural flow diagram 600 of FIG. 6, according to an embodiment. As illustrated by FIG. 7, both a computer 706 and a database 708 may feed data to a central SOR 710. The data may then be distributed among a plurality of SORs or stream-processing platforms 712 (e.g., Apache Kafka), that make up a modernized SOR component 714. After the data is processed by each of the plurality of stream-processing platforms 712 the data is transmitted to a customer interface event processor 718, which is part of the customer interaction core component 724 and includes a plurality of listener modules 716 for reviewing the event data that has been processed. The data is then transmitted from the customer interface event processor 718 to a customer interface revised schema 720, which includes the stream-processing platforms 712. The data is then processed by the customer interface event processor 718 and transmitted out of the customer interaction core component 724 to the data transformation routing rules module 726 that makes up the event segmentation component 728. The data transformation routing rules module 726 may then separate the transformed data to respective stream-processing platforms 712.

Additionally, as illustrated by FIG. 7, an API 738 may transmit data to a research, development, and integration module 734, which is part of the reference data component 736, for enhancing the data and then transmitting the data to a metadata module 730 that also receives information from a user interface 732. Once the data is processed and stored by the metadata module 730 it is transmitted to the data transformation routing rules module 726, which further uses this data for transforming the data that is sent to the respective stream-processing platforms 712.

Furthermore, as illustrated by FIG. 7, the data from the customer interface event processor 718 may also be transmitted to a plurality of distributed databases (e.g., Apache Cassandra) 722 for storage. The data may then be retrieved by the API 738 that is in connection with a customer interface API 740, which together make up the API component 742.

Moreover, as illustrated by FIG. 7, the data transformation artifact 702 may perform validation, transformation, and enrichment on received data. The data transformation artifact 702 may be the same or similar to the data transformation artifact 602 illustrated in FIG. 6. The data may then be transmitted from the data transformation artifact 702 to the customer interaction event processor 718 for further review and processing. The data from the data transformation artifact 702 may also be transmitted to a customer interaction platform (e.g., Concordia) that processes the data and transmits it to the API 738 and a cross-reference module 746. The data from one or more of the listener components 716 may be transmitted to a stream-processing platform 712 that processes the data based on the DSL and then transmits the data to a customer interaction software customization (e.g., Bytecraft) module 748 that modifies the application software data and then transmits it to a distributed database (e.g., Cassandra) enrichment module 750 for enriching the data.

Also, as illustrated by FIG. 7, data from the customer interaction event processor 718 may also be transmitted to a stream-processing platform 712(b) as part of a cybersecurity (e.g., Soteria) component 756. As part of the cybersecurity component 756, an API 738 may transmit data to a customer interaction cybersecurity (e.g., Soteria) module 752. Event data that fails analysis by the customer interaction cybersecurity module 752 may transmit the failed data to a failed events module 754, which processes the data and transmits it back to the API 738. Event data that passes analysis by the customer interaction cybersecurity component 752 is transmitted to a stream-processing platform 712(a). Upon processing of the event data, the data may be passed to the stream-processing platform 712(b) and/or a listener module 716.

By this process, the technical flow diagram 700 transforms data from a variety of sources and formats into a custom singular format that facilitates data processing across a plurality of platforms.

In an embodiment, data transformation device 302 may be a programming language (e.g., Java) component that utilizes a DSL to define data transformation, enrichment, and/or filtering actions that can be executed on event data during a consumption action. The rules may be codified in a standard text-based format (e.g., JSON) file used by the data transformation device 302 as part of a consumer application (e.g., Photon) to apply changes to event data. The data transformation device 302 may abstract the rules out of the source code so that changes in rules can be developed and applied more dynamically.

The data transformation device 302 may optimize data processing in event-driven architectures. The data transformation device 302 may be a custom-built platform that employs a DSL to manage data transformation, validation, and mapping within event streams. The system may incorporate a novel use of a cache manager to enhance rule processing performance, ensuring low-latency and high-throughput event handling. The data transformation device 302 may uniquely integrate various computing languages (e.g., SpEL and JSONPath) within the DSL, offering a unified language for complex data processing tasks. The data transformation device 302 may be particularly advantageous for distributed systems requiring real-time data processing and minimal custom code for individual events.

The data transformation device 302 may pertain to the field of data processing within event-driven architectures. It may provide a system and method for efficiently transforming, validating, and mapping data using a custom DSL, enhanced by caching mechanisms to optimize rule execution.

The key components of the data transformation device 302 may include: 1) Custom DSL that consolidates transformation, validation, and mapping operations within a single language framework. This DSL may support simple, list, object, and optional chaining expressions, integrating various computing languages (e.g., SpEL and JSONPath) to handle complex data structures. 2) Cache manager that caches frequently used rules and precomputed results, thereby significantly reducing redundant computations and improving overall system performance. The cache mechanism may be integrated into the rule processing pipeline, ensuring that only necessary computations are performed on incoming events. 3) Platform Agnosticism, such that the system is designed to be deployed across various cloud environments, both public and private, making it versatile and adaptable to different infrastructure setups.

Events may be ingested into the data transformation device 302, where they may be wrapped in a canonical model that provides a consistent structure for subsequent processing. The canonical model ensures that disparate event types may be handled uniformly. Additionally, the DSL may interpret and apply rules to the event stream. These rules are defined to handle the transformation, validation, and mapping of data. The integration of various computing languages (e.g., SpEL and JSONPath) may allow for complex operations on nested data structures. The cache manager may optimize this process by storing commonly used rules and results, ensuring that the system performs only necessary computations, thereby reducing latency.

Regarding validation, ingested events may be validated against conditional rules which evaluate the dynamic values of the field on both the logical type and functional value of the field. The branching rules and conditional rules may be used to either filter out the incoming event or respond with a custom exception code.

Regarding enrichment, target data may need to be enriched based on certain fields/logic. The data transformation device 302 may enable this process by enriching reference data by querying the connected database and by calling configured APIs.

Regarding workflow execution, workflows may be defined and executed based on the rules provided by the DSL. These workflows may be customized for events, allowing for real-time data processing with minimal custom code. The cache manager may further accelerate workflow execution by reducing the overhead associated with rule evaluation. Once processed, the transformed and validated data may be emitted back into a downstream streaming platform system. The system may support integration with various external systems, ensuring seamless data flow across the architecture. The system may also perform multi-threading for parallel processing of transformation and for providing multiple threads of execution concurrently. The system may also include enhanced logging for granular information on metadata for processing, thereby enabling streamlined observability and monitoring.

The data transformation device 302 may provide a plurality of benefits including: 1) Enhanced Entity Definition: the data transformation device 302 may extend entity definitions based on pivotal elements and adhere to various rules such as 1:1 and 1:n relationships. This may provide a flexible and scalable approach to modeling and managing complex data relationships within the event data streams. 2) Domain-Specific Expression Language: the data transformation device 302 may incorporate a domain-specific expression language, allowing organizations to define rules and extraction logic specific to their business domain. This may empower data experts and domain specialists to express complex business rules in a concise and intuitive manner. 3) Dynamic Rule Application: the data transformation device 302 may enable the dynamic application of rules by utilizing external configuration sources such as databases or configuration services, in order to allow rules to be modified or added on the fly without requiring the stream processing application to be restarted. The data transformation device 302 may provide real-time adaptability and flexibility to accommodate evolving product requirements. 4) Rules and Policies: the data transformation device 302 may simplify the development of rules and policies by utilizing a DSL. This language may allow users to define rules for filtering, aggregating, enriching, or modifying events based on specific conditions or business logic. With the data transformation device 302, teams may easily implement and manage complex data processing rules within their data streams. 5) Integration and Scalability: The data transformation device 302 may seamlessly integrate with existing data processing pipelines and may scale to handle large volumes of data. It may support integration with popular stream processing frameworks, ensuring compatibility and adaptability to diverse environments. 6) Continuous Improvement: the data transformation device 302 may foster a culture of continuous improvement by facilitating updates to rules and policies. Organizations may evolve their data governance and validation strategies as data requirements evolve, ensuring ongoing alignment with business needs.

Accordingly, with this technology, an optimized process for transforming data from a variety of sources and formats into a custom singular format that facilitates data processing across a plurality of platforms is provided.

Although the invention has been described with reference to several exemplary embodiments, it is understood that the words that have been used are words of description and illustration, rather than words of limitation. Changes may be made within the purview of the appended claims, as presently stated, and as amended, without departing from the scope and spirit of the present disclosure in its aspects. Although the invention has been described with reference to particular means, materials, and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually, and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

1. A method for streamlining data processing by transforming data, the method being implemented by at least one processor, the method comprising:
receiving, by the at least one processor, first data that relates to a customer interaction event from at least one system of record (SOR);
validating, by the at least one processor via a domain specific language (DSL), the first data based on a first series of rules to confirm that each datum from the first data is capable of being transformed;
generating, by the at least one processor, second data by removing each datum from the first data that is incapable of being transformed;
transforming, by the at least one processor, the second data from a first format to a second format based on a second series of rules, wherein the second format is a standardized DSL format that is recognizable by each SOR; and
transmitting, by the at least one processor, the transformed second data to each respective SOR.

2. The method of claim 1, further comprising:
augmenting, by the at least one processor via a database and at least one application programming interface (API), the transformed second data with historical reference data.

3. The method of claim 1, wherein the validating comprises applying a set of conditional rules to evaluate a dynamic value of the first data based on a predetermined logical type and a predetermined functional value.

4. The method of claim 1, further comprising:
storing, by the at least one processor via a cache manager, a cache of at least one from among frequently used rules that relate to previous transformations of prior data and previously computed results that relate to the previous transformations of prior data,
wherein information associated with the cache is used to reduce a number of computations required for the transforming of the second data.

5. The method of claim 1, further comprising:
defining, by the at least one processor, a customer interaction event response workflow based on the transformed second data and a set of workflow rules associated with the DSL; and
executing, by the at least one processor, the defined customer interaction event response workflow based on the set of workflow rules.

6. The method of claim 1, wherein the customer interaction event comprises at least one from among a customer checking a detail of an account, a request for a new banking card, a request to add a new payment to the account, and a transaction associated with the account.

7. The method of claim 1, further comprising:
generating, by the at least one processor via a machine learning model, a summary of the transformed second data that describes the customer interaction event.

8. The method of claim 7, further comprising:
analyzing, by the at least one processor via the machine learning model, the generated summary to interpret the transformed second data, determine a pattern, and generate a recommended responsive action.

9. The method of claim 1, wherein the at least one SOR comprises a stream-processing platform.

10. A computing apparatus for streamlining data processing by transforming data, the computing apparatus comprising:
a processor;
a memory; and
a communication interface coupled to each of the processor and the memory,
wherein the processor is configured to:
receive first data that relates to a customer interaction event from at least one system of record (SOR);
validate, via a domain specific language (DSL), the first data based on a first series of rules to confirm that each datum from the first data is capable of being transformed;
generate second data by removing each datum from the first data that is incapable of being transformed;
transform the second data from a first format to a second format based on a second series of rules, wherein the second format is a standardized DSL format that is recognizable by each SOR; and
transmit the transformed second data to each respective SOR.

11. The computing apparatus of claim 10, wherein the processor is further configured to augment, via a database and at least one application programming interface (API), the transformed second data with historical reference data.

12. The computing apparatus of claim 10, wherein the processor is further configured to apply a set of conditional rules to evaluate a dynamic value of the first data based on a predetermined logical type and a predetermined functional value.

13. The computing apparatus of claim 10, wherein the processor is further configured to:
store, via a cache manager, a cache of at least one from among frequently used rules that relate to previous transformations of prior data and previously computed results that relate to the previous transformations of prior data,
wherein information associated with the cache is used to reduce a number of computations required for the transforming of the second data.

14. The computing apparatus of claim 10, wherein the processor is further configured to:
define a customer interaction event response workflow based on the transformed second data and a set of workflow rules associated with the DSL; and
execute the defined customer interaction event response workflow based on the set of workflow rules.

15. The computing apparatus of claim 10, wherein the customer interaction event comprises at least one from among a customer checking a detail of an account, a request for a new banking card, a request to add a new payment to the account, and a transaction associated with the account.

16. The computing apparatus of claim 10, wherein the processor is further configured to generate, via a machine learning model, a summary of the transformed second data that describes the customer interaction event.

17. The computing apparatus of claim 16, wherein the processor is further configured to:
analyze, via the machine learning model, the generated summary to interpret the transformed second data, determine a pattern, and generate a recommended responsive action.

18. The computing apparatus of claim 10, wherein the at least one SOR comprises a stream-processing platform.

19. A non-transitory computer readable storage medium storing instructions for streamlining data processing by transforming data, the storage medium comprising executable code which, when executed by a processor, causes the processor to:
receive first data that relates to a customer interaction event from at least one system of record (SOR);
validate, via a domain specific language (DSL), the first data based on a first series of rules to confirm that each datum from the first data is capable of being transformed;
generate second data by removing each datum from the first data that is incapable of being transformed;
transform the second data from a first format to a second format based on a second series of rules, wherein the second format is a standardized DSL format that is recognizable by each SOR; and
transmit the transformed second data to each respective SOR.

20. The storage medium of claim 19, wherein the executable code further causes the processor to augment, via a database and at least one application programming interface (API), the transformed second data with historical reference data.
